(19) United States
(12) Patent Application Publication
(10) Pub. No.: US 2010/0258456 A1
(43) Pub. Date: Oct. 14, 2010

(54) KEYBOARD CADDY

(75) Inventor: Thomas BORSE, Woodridge, IL (US)

Correspondence Address: Momkus McCluskey, LLC, 1001 Warrenville Road, Suite 500, Lisle, IL, 60532, US

(73) Assignee: ANGLE PATTERN AND MOLD CORPORATION, Burr Ridge, IL (US)

(21) Appl. No.: 12/422,400

(22) Filed: Apr. 13, 2009

(51) Int. Cl. A45C 11/34; G06F 3/02

(52) U.S. Cl. 206/214

(57) ABSTRACT

A desktop organizer for association with a keyboard having legs comprises a body having one or more compartments and two keyboard attachment sections that are integrally formed with the body. Each keyboard attachment section includes a plurality of recesses that are each adapted to receive a foot of a keyboard.

### BACKGROUND OF THE INVENTION

Increasingly, many tasks are done at a keyboard and in front of a display. Desktop organizers are used to keep office workspaces clear and orderly by storing the commonly used items such as paperclips, pens, pencils, rubber bands, erasers, and the like. Organizing such office supplies increases worker productivity by decreasing the amount of time lost looking for particular items. Additionally, organized work environments reduce worker frustration and enhance a sense of control over the amount of work to be accomplished.

A wide variety of desktop organizers are available but are frequently out of reach because they are not proximate to or secured to the keyboard. Prior art organizers that attach to the keyboard are inadequate because they use adhesives to attach the organizer to the keyboard, which makes adjustments or removal of the organizer difficult. Additionally, this often leaves the keyboard sticky with adhesive that was not completely removed.

Additionally, coffee cups or other beverage containers are frequently present on the desktop and are at risk of being spilled by the worker when he or she reaches for other items. Therefore, there exists a need for a desktop organizer that is secured to the keyboard so that the items are always in a fixed position relative to the keyboard.

### SUMMARY OF THE INVENTION

According to one aspect of the invention, an organizer for association with a computer keyboard comprises a body having a right end, a left end spaced from the right end, and at least one compartment between the right end and the left end for receiving office supplies and the like. Additionally, the organizer comprises a first keyboard attachment section integrally formed with the right end of the body and a second keyboard attachment section integrally formed with the left end of the body and being spaced from the first keyboard attachment section by a rearward length. Each keyboard attachment section includes a plurality of recesses, with each recess being separated from the others by an upstanding wall. The recesses are each adapted to receive a foot of a keyboard.

Preferably, the recesses have an opening and a bottom, with an area of the opening being greater than the area at the bottom such that the legs of a keyboard register to a predetermined widthwise position when placed in the recesses.

In addition, the organizer may include compartments for other items commonly found in a workspace. For example, the organizer may include one or more cup holders to prevent spillage in the event the user accidentally jars the cup. The cup holder itself may be sized to fit two or more sizes of cups, having a first receiving surface that is lower than, smaller than, and substantially surrounded by the second receiving surface. Preferably, the first receiving surface is coplanar with the bottom of a second storage compartment.

### BRIEF DESCRIPTION OF THE DRAWINGS

Further aspects of the invention and their advantages can be discerned in the following detailed description, in which like characters denote like parts and in which:

FIG. 1 is a plan view of a first embodiment of the invention;

FIG. 2 is an elevational view taken substantially along line 2-2 of FIG. 1;

FIG. 3 is an elevational view taken substantially along line 3-3 of FIG. 1;

FIG. 4 is a side elevational view of the embodiment shown in FIGS. 1-3, as it is being attached to a keyboard;

FIG. 5 is a top view of the embodiment shown in FIGS. 1-3, after it is attached to the keyboard;

FIG. 6 is an elevational view taken substantially along line 6-6 of FIG. 5, with the legs of the keyboard being shown in phantom; and

FIG. 7 is a top view of a second embodiment of the invention, where two of the storage compartments are cupholders.

### DETAILED DESCRIPTION

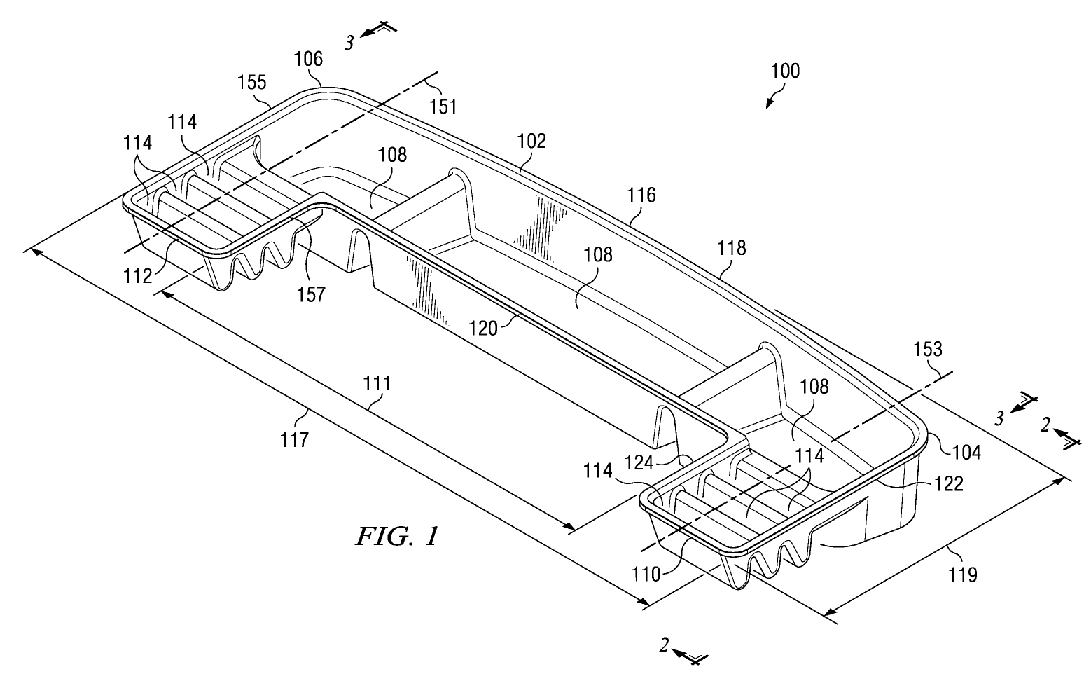

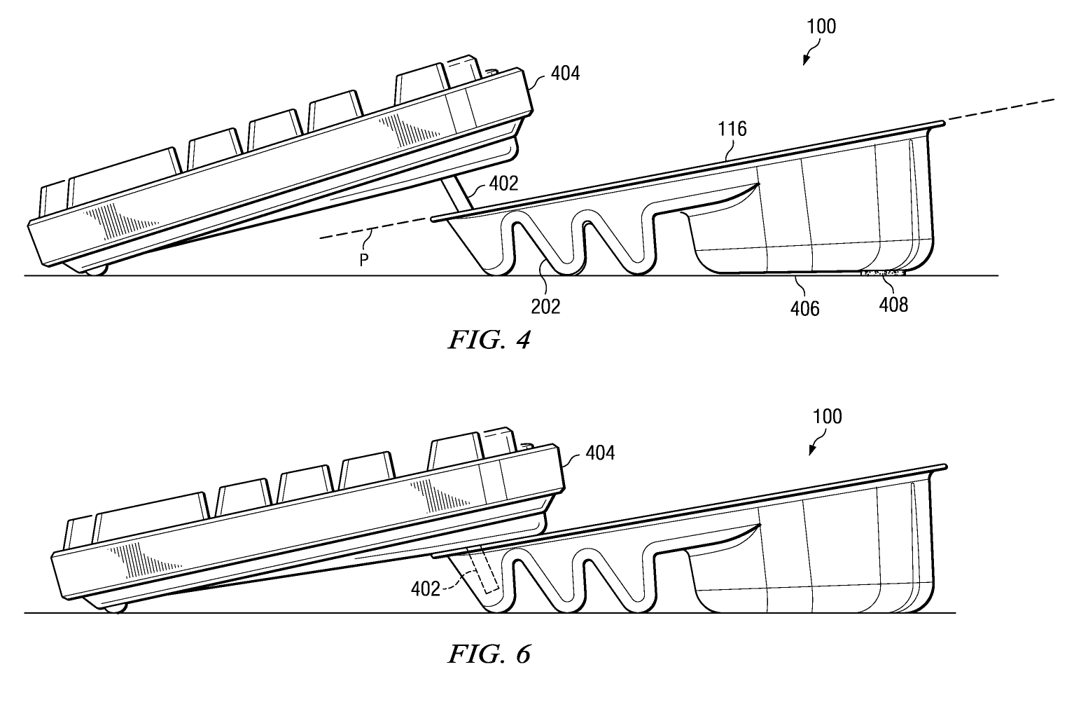

Referring to FIGS. 1 and 4, an organizer, indicated generally at 100, comprises a body 102 having a right end 104 and a left end 106 spaced from the right end and one or more compartments 108 between the right end 104 and the left end 106 for receiving office supplies and the like. The organizer 100 further comprises a first keyboard attachment section 110 integrally formed with the right end 104 of the body 102 and a second keyboard attachment section 112 integrally formed with the left end 106 of the body 102 spaced from the first keyboard attachment section 1 10. Each keyboard attachment section 110, 112 includes a plurality of recesses 114 with each recess 114 being separated from the others by an upstanding wall 202 and being adapted to receive a leg 402 of a keyboard 404.

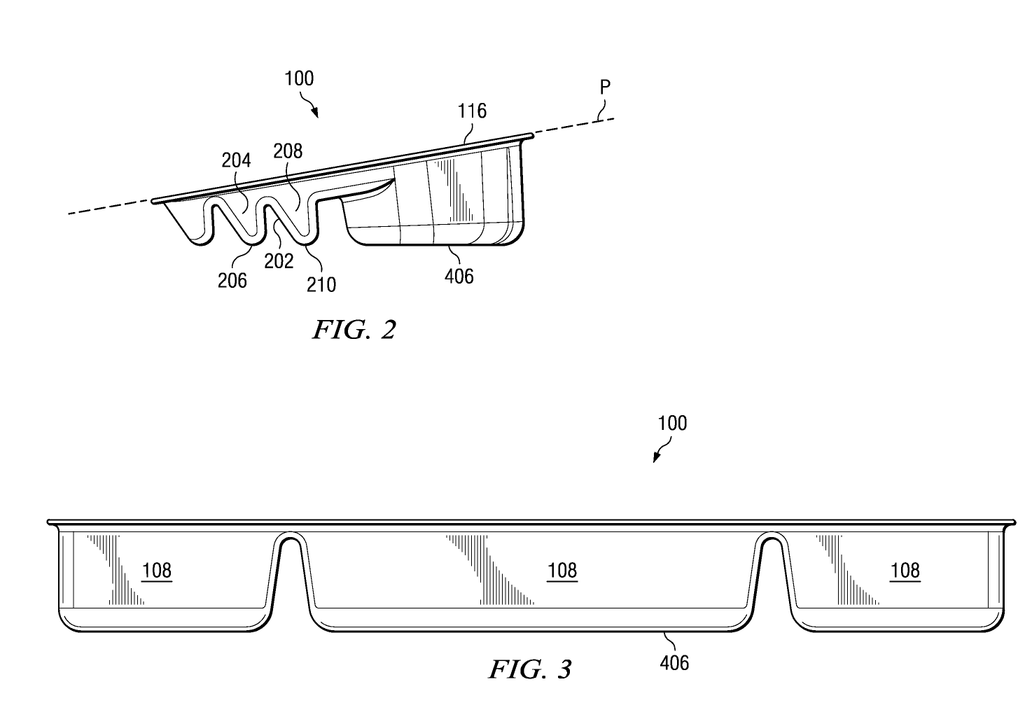

Referring to FIGS. 2 and 4, the first and second keyboard attachment sections 110, 112 preferably are longitudinally spaced apart by a rearward length 111 which is chosen to be less than a length of most standard computer keyboards. Lateral centers 151 and 153 of the respective attachment sections 110, 112 are chosen to be spaced apart by a length that approximates the spacing of the legs of a conventional keyboard. Each recess 114 has an opening 204 and a bottom 206. More preferably, an area 208 of the opening 204 is greater than the area 210 at the bottom 206 of the recess 114 such that the legs 402 of the keyboard 404 register to predetermined width positions when placed in any of the recesses 114. Additionally, the length of each recess 114 and their spacings apart from each other, should be wide enough to support a range of keyboard leg 402 spacings.

The organizer 100 has a length 117 and a width 119 that is smaller than the last said length and may further include a circumferential lip 116 around a perimeter of the body 102, the first keyboard attachment section 110, and the second keyboard section 112. The circumferential lip 116 comprises a forward margin 118, an inner margin 120 spaced rearwardly from the forward margin 118 and oriented in a length direction, right and left lateral exterior margins 122, 155 oriented in a width direction, left and right lateral interior margins 124, 157 oriented in a width direction spaced laterally and interiorly from the lateral exterior margins 122, 155. Preferably, upper surfaces of the forward margin 118, the lateral interior margins 124, 157, the lateral exterior margins 122, 155, and the inner margin 120 substantially conform to a single plane P.

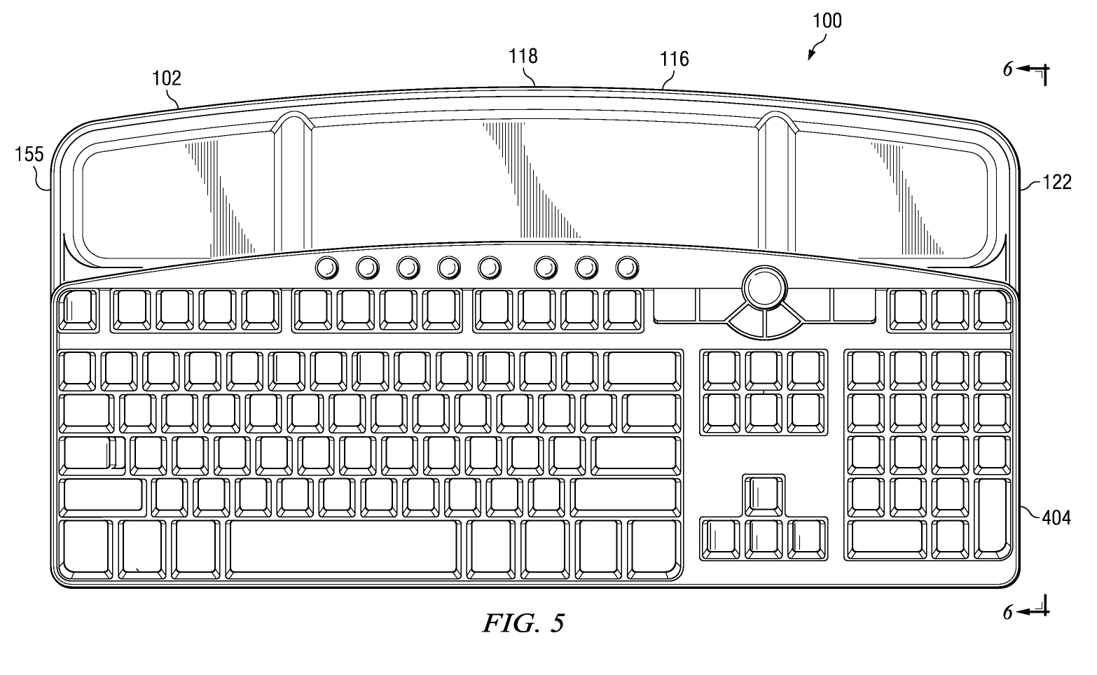

Since many keyboards are inclined to promote user comfort, the plane P may be inclined rearwardly and downwardly from the front side to the rear side as depicted in FIG. 2. Additionally, the upstanding wall 202 may be lower than the circumferential lip 116 so that the upstanding wall 202 is not supporting the keyboard 212. Further, the circumferential lip 116 may have two lateral interior margins 124, 157 oriented in a width direction and parallel to each other. FIG. 5 shows the organizer being used in conjunction with a keyboard 404.

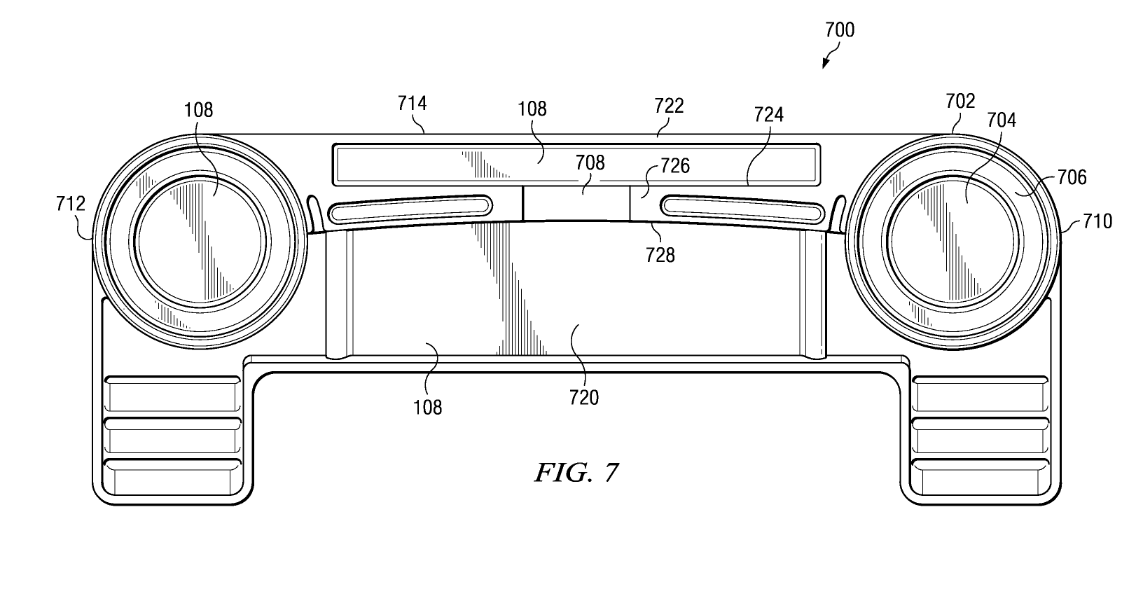

Referring to FIGS. 1 and 7, the organizer 100 may have a plurality of storage compartments 108. In the embodiment shown in FIG. 7, two of the compartments 108 are cupholders 702. The cupholder 702 may have at least a first receiving surface 704 and a second receiving surface 706, the first receiving surface 704 being lower than, smaller than, and substantially surrounded by the second receiving surface 706. Preferably, the first receiving surface 704 is substantially coplanar with a bottom of a second storage compartment 720. Further, the organizer 100 may have an underside 406 (FIG. 4) with one or more surface engagement devices 408 that engage the surface upon which the organizer sits and prevent movement. These surface engagement devices 408 may be made of felt, rubber, adhesive tape, putty, adhesive foam, or plastic.

Referring back to FIG. 7, the organizer, indicated generally at 700, may also have a stiffening member 708 between the right end 710 and left end 712 that acts to stiffen the body 714 against flexion out of the horizontal plane. Stiffening member 708 is formed as an inverted “U”. From the bottom of a forward storage compartment 722, a forward upstanding sidewall 724 extends upwardly and terminates in a horizontal plate 726. Plate 726 extends horizontally and rearwardly and is terminated by a rearward upstanding sidewall 728, which in turn extends from plate 726 to the bottom of rearward compartment 720. As so constructed, member 708 will resist bending or flexion forces acting orthogonally to the plane of the paper, as might be imposed on organizer 700 by putting a drink-filled cup into one of the cupholders 702.

Finally, the organizer 100 may be made through techniques such as injection molding or thermoforming. If thermoforming is used, the body 102, first keyboard attachment section 110, and second keyboard attachment section 112 are preferably formed from a single sheet of material having a substantially uniform thickness.

In summary, the organizer provides a cost effective way of securing an organizer to a keyboard so that the user may reduce clutter in the work area and increase worker efficiency.

While illustrated embodiments of the present invention have been described and illustrated in the appended drawings, the present invention is not limited thereto but only by the scope and spirit of the appended claims.

1. An organizer for association with a computer keyboard, comprising:
a body having a right end, a left end spaced from the right end in a lengthwise direction, and a front side extending from the right end to the left end and oriented in the lengthwise direction;
at least one storage compartment between the right end and the left end for receiving office supplies and the like, a general rear side of the body spaced in a widthwise direction from the front side of the body by said at least one storage compartment, the general rear side oriented in a lengthwise direction;
a first keyboard attachment section integrally formed with the right end of the body to extend rearwardly in relation to the general rear side of the body; and
a second keyboard attachment section integrally formed with the left end of the body, the second keyboard attachment section spaced from the first keyboard attachment section in a lengthwise direction by the general rear side of the body, the second keyboard attachment section extending rearwardly in relation to the general rear side of the body;
wherein each keyboard attachment section includes a plurality of recesses, each recess being separated from the others by an upstanding wall and being adapted to receive a foot of the keyboard.

2. The organizer of claim 1, wherein centers of the first and second keyboard attachment sections are longitudinally spaced apart by a length which approximates a spacing apart of the legs of a standard computer keyboard.

3. The organizer of claim 1, wherein each of the first and second keyboard attachment sections has a rear side which is rearwardly spaced from the general rear side of the body, each recess having an opening and a bottom, an area of the opening being greater than an area of the bottom of the recess, each bottom of a recess defining a respective predetermined widthwise position which is spaced rearwardly from the general rear side of the body and which is spaced forwardly from the rear side of the attachment section in which the recess is located, the bottoms of the recesses in any attachment section being spaced in a widthwise direction from each other, such that the foot of the keyboard received by a respective keyboard attachment section will register to one of the predetermined widthwise positions defined by a respective one of the recesses.

4. The organizer of claim 1, wherein each recess is long enough in a lengthwise direction to support a range of keyboard leg spacings.

5. The organizer of claim 1, further comprising a circumferential lip extending around a perimeter of the body, the first keyboard attachment section, and the second keyboard attachment section in a lateral direction.

6. The organizer of claim 5, wherein said upstanding wall is lower than the circumferential lip.

7. The organizer of claim 5, wherein the organizer has a length and a width that is smaller the last said length, and the circumferential lip comprises a forward margin, an inner margin spaced rearwardly from the forward margin and oriented in a length direction, right and left lateral exterior margins oriented in a width direction, and left and right lateral interior margins oriented in a width direction and spaced laterally and interiorly from the lateral exterior margins.

8. The organizer of claim 7, wherein upper surfaces of the forward margin, the lateral interior margins, lateral exterior margins, and inner margin are in the same plane.

9. The organizer of claim 8, wherein the plane is inclined rearwardly and downwardly from the front side of the body to the general rear side of the body.

10. The organizer of claim 7, wherein left and right lateral interior margins are each oriented in a width direction and parallel to each other.

11. The organizer of claim 1, wherein the body is formed of a single sheet of material having a substantially uniform thickness.

12. The organizer of claim 1, wherein said at least one storage compartment is a cupholder.

13. The organizer of claim 12, wherein said cupholder has at least a first receiving surface and a second receiving surface, the first receiving surface being lower than, smaller than, and substantially surrounded by the second receiving surface.

14. The organizer of claim 13, wherein the first receiving surface is substantially coplanar with a bottom of a second storage compartment.

15. The organizer of claim 1, wherein said at least one storage compartment is one of a plurality of storage compartments.

16. The organizer of claim 1, further comprising an underside having at least one surface engagement device for engaging a surface upon which the organizer sits.

17. The organizer of claim 16, wherein the surface engagement device is selected from the group consisting of felt, rubber, adhesive tape, putty, adhesive foam, or plastic.

18. The organizer of claim 1, wherein the body further comprises a stiffening member between the right end and the left end that acts to stiffen the body against flexion out of the horizontal plane.
